(19) United States
(12) Patent Application Publication
(10) Pub. No.: US 2019/0109992 A1
(43) Pub. Date: Apr. 11, 2019

(54) CONTROL APPARATUS, IMAGING APPARATUS, CONTROL METHOD, AND STORAGE MEDIUM

(71) Applicant: CANON KABUSHIKI KAISHA, Tokyo (JP)

(72) Inventor: Kazuhiko Momoki, Koshigaya-shi (JP)

(21) Appl. No.: 16/149,603

(22) Filed: Oct. 2, 2018

(30) Foreign Application Priority Data
Oct. 5, 2017 (JP) 2017-194919

(51) Int. Cl. H04N 5/232; H04N 5/225; G02B 7/04

(52) U.S. Cl. CPC H04N 5/23296; G02B 7/04; H04N 5/2254

(57) ABSTRACT

A control apparatus configured to control a lens apparatus having an operating unit for an optical zoom through a manual operation and an imaging apparatus configured to provide a digital zoom includes a first processor configured to determine a magnification of the digital zoom from a wide-angle end to a telephoto end based on information on a position of the operating unit, and a second processor configured to cause the imaging apparatus to perform the digital zoom based on an output from the first processor.

### BACKGROUND OF THE INVENTION

### Field of the Invention

The present invention relates to an imaging (image pickup) apparatus that can provide the optical zoom by a manual operation.

### Description of the Related Art

A conventional imaging apparatus, such as a digital still camera and a video camera, typically provide the optical zoom and the digital zoom (electronic zoom). Japanese Patent Laid-Open No. (“JP”) 6-86131 discloses a video camera that can continuously operate optical zoom and digital zoom as a zoom lever is manipulated.

A general digital single-lens reflex camera is configured to provide optical zoom (manual zoom) by directly operating a lens apparatus (interchangeable lens), and thus cannot provide the optical zoom using the zoom lever as disclosed in JP 6-86131.

A general digital single-lens reflex camera provides the digital zoom via a switch on the camera body independently of the optical zoom operation. For zooming from a wide-angle end of the optical zoom to a maximum telephoto end with the digital zoom, it is necessary to independently perform the optical zoom operation on the lens apparatus side and the digital zoom operation on the camera body side. Due to this configuration, the continuous zoom operation is difficult particularly in motion imaging.

### SUMMARY OF THE INVENTION

The present invention provides a control apparatus, an imaging apparatus, a control method, and a storage medium, each of which can provide smooth digital zoom via a manual operation.

A control apparatus according to one aspect of the present invention is configured to control a lens apparatus having an operating unit for an optical zoom through a manual operation and an imaging apparatus configured to provide a digital zoom and includes a first processor configured to determine a magnification of the digital zoom from a wide-angle end to a telephoto end based on information on a position of the operating unit, and a second processor configured to cause the imaging apparatus to perform the digital zoom based on an output from the first processor.

An imaging apparatus according to another aspect of the present invention includes the above control apparatus, and an image sensor configured to photoelectrically convert an optical image formed by the lens apparatus.

A control method according to another aspect of the present invention configured to control a lens apparatus having an operating unit for an optical zoom through a manual operation and an imaging apparatus configured to provide a digital zoom includes the steps of determining a magnification of the digital zoom from a wide-angle end to a telephoto end based on information on a position of the operating unit; and causing the imaging apparatus to perform the digital zoom based on the magnification.

A storage medium according to another aspect of the present invention stores a program that enables a computer to execute the above control method.

Further features of the present invention will become apparent from the following description of exemplary embodiments with reference to the attached drawings.

### BRIEF DESCRIPTION OF THE DRAWINGS

FIG. 1 is a schematic diagram of an imaging apparatus according to a first embodiment.

FIG. 2 is a graph showing a relationship between a focal length change caused by optical zoom and a focal length change caused by digital zoom according to the first embodiment.

FIG. 3 is a schematic diagram of an imaging apparatus according to a second embodiment.

FIG. 4 is a graph showing a relationship between a focal length change caused by optical zoom and a focal length change caused by digital zoom according to the second embodiment.

FIG. 5 is a graph showing a change of a digital zoom magnification using a zoom FPC.

FIG. 6 is a graph showing a change of a digital zoom focal length using the zoom FPC.

FIG. 7 is an illustrative filter about a time response according to the second embodiment.

FIG. 8 is a graph showing a change of a digital zoom magnification after smooth processing according to the second embodiment.

### DESCRIPTION OF THE EMBODIMENTS

Referring now to the accompanying drawings, a detailed description will be given of embodiments according to the present invention.

### First Embodiment

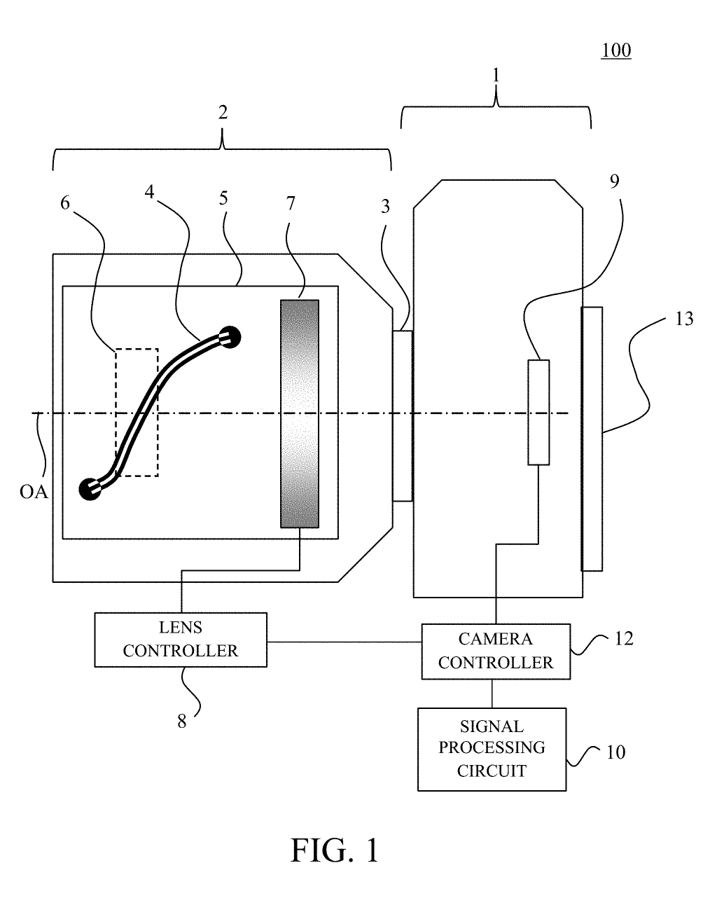

Referring now to FIG. 1, a description will be given of a configuration of an imaging apparatus according to a first embodiment of the present invention. FIG. 1 is a schematic diagram of an imaging apparatus (digital single-lens reflex camera) 100. The imaging apparatus 100 includes a camera body 1 and an imaging lens (interchangeable lens) 2 that can be attached to and detached from the camera body 1. The camera body 1 and the imaging lens 2 are connected to each other via a detachable mount 3.

In the imaging lens 2, a zoom cam barrel (zoom ring, operating unit) 5 is rotated by a zoom operation (manual operation) of a user. A zoom cam 4 is formed in the zoom cam barrel 5. As the zoom cam cylinder 5 rotates, a zoom drive lens unit 6 moves in a direction of an optical axis OA in the imaging lens 2 (the optical axis direction) along a locus of the zoom cam 4. A zoom encoder 7 can obtain information on a zoom position of the imaging lens 2 by detecting a rotation position (rotational operation position) of the zoom cam barrel 5. The manual operation is not limited to the direct manual operation of the zoom ring by the user, and may include an indirect operation of the zoom ring, such as by driving a motor with a button.

A lens controller 8 is disposed in the imaging lens 2, communicates with a camera controller (calculator, first processor) 12 in the camera body 1, and controls driving of an imaging optical system (zoom lens), such as an aperture stop and a focus lens (not illustrated). The lens controller 8 detects the position of the zoom cam barrel 5 through a zoom encoder 7, acquires information on the zoom position (focal length), and communicates a parameter corresponding to the zoom position to the camera controller 12. An image sensor 9 photoelectrically converts an optical image formed by the imaging optical system including a zoom driving lens unit 6, and outputs image data. The camera controller 12 performs image processing for the image data output from the image sensor 9, and stores the processed image data in a memory or storage unit (not illustrated).

A description will now be given of an outline of the digital zoom. By trimming a screen size of a solid-state image sensor, the digital zoom has the same effect as the telephoto zoom in the optical zoom, and can increase the magnification on the telephoto side. The angle of view is smaller on the telephoto side in the optical zoom, but the digital zoom reproduces the same angle of view by cutting out part of an imaging plane. Although the imaging magnification of the object does not change, the ratio of the object size to the entire screen increases and the same effect as that of the zoom can be obtained. The digital zoom has the reduced available number of pixels and the lower resolution, but a high pixel solid-state image sensor is sufficiently practical. Particularly, in motion imaging with a relatively small output image size or in imaging with a cellular phone camera, the number of pixels of the solid-state image sensor has a margin and provides a large digital zoom ratio without any deteriorations.

When the user manipulates the camera body 1 and turns on a digital zoom function, a signal processing circuit (second processor) 10 in the camera body 1 performs the digital zoom for a captured image. In the digital zoom, the camera controller 12 initially communicates with the lens controller 8 and acquires a wide-angle end focal length fw and a telephoto end focal length ft of the imaging lens 2. These values are invariable unless the lens is exchanged, and stored in a memory in the camera controller 12.

Next, the camera controller 12 acquires the current focal length of the imaging lens 2 by communicating with the lens controller 8. The lens controller 8 calculates the focal length f of the imaging lens 2 based on the information on the zoom encoder 7 in the imaging lens 2, and transmits the focal length f to the camera controller 12.

A digital zoom magnification kx is calculated by the following equation (1) using the wide-angle end focal length fw, the telephoto end focal length ft, the focal length f, and the maximum zoom magnification kmax.

kx=(k max−1)*(ft−f)/(ft−fw)+1 (1)

An image output from the image sensor 9 and sent to the signal processing circuit 10 is enlarged by the digital zoom magnification kx and displayed on a back monitor (display unit) 13. This image is recorded as a motion or still image depending on an imaging mode.

The user can provide a zoom operation of the imaging lens 2 at any time. The zoom operation enables the lens controller 8 to detect a rotational amount of the zoom cam barrel 5 through the value of the zoom encoder 7. A change of the focal length f caused by the zooming is sequentially transmitted to the camera controller 12, which recalculates the magnification kx of the digital zoom according to the equation (1). The zoom encoder 7 can accurately detect the zoom position. The frequent recalculations as described above enable the digital zoom magnification to continuously change.

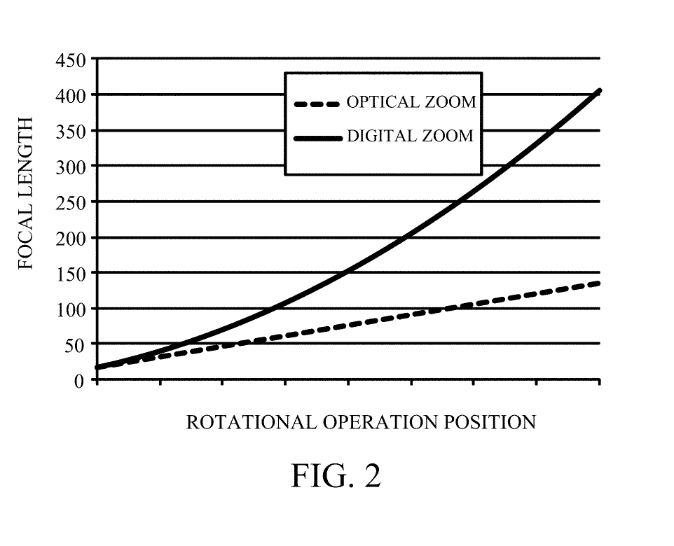

Referring now to FIG. 2, a description will be given of a relationship between the focal length change caused by the optical zoom in the zoom operation and the focal length change caused by the digital zoom. FIG. 2 is a graph showing the relationship between the focal length change caused by the optical zoom in the zoom operation and the focal length change caused by the digital zoom. The graph in FIG. 2 sets the maximum zoom magnification kmax to 3.0 for a zoom lens having a focal length of 18 mm to 135 mm. In FIG. 2, the ordinate axis represents the focal length. The abscissa axis represents the rotational operation position (focal length in the optical zoom) of the zoom cam barrel 5 where the wide-angle end is located on the left side and the telephoto end is located on the right side. A broken line represents a focal length change caused by the optical zoom, and the focal length continuously varies from 18 mm to 135 mm. Then, the digital zoom magnification kx continuously varies from 1.0 to 3.0 according to the equation (1). The focal length multiplied by them (digital zoom focal length as a combination of the optical zoom and the digital zoom) continuously varies from 18 mm to 405 mm as illustrated by the solid line in FIG. 2. This configuration can provide a high magnification-varying zoom lens with a zoom magnification corresponding to 22.5 times.

Particularly, the motion imaging is required to continuously capture movements of the object from a short distance to a long distance in a seamless manner. A motion image dedicated camcorder usually uses a compact zoom lens with a high zoom ratio. However, in a digital single-lens reflex camera having a large image sensor size, an optical zoom lens exceeding 20 times is large in size and expensive, so that the configuration according to this embodiment is effective.

The digital zoom is generally performed in the so-called live-view. The motion imaging continues while a shutter remains open. The optical viewfinder cannot be used, and an object is continuously observed on an electronic viewfinder (EVF). When a motion imaging start button is pressed, a motion image is recorded. Alternatively, when the shutter button is pressed, a still image is recorded. In either case, an image can be captured with an angle of view shown on the EVF.

The digital zoom is also available in the normal imaging through the optical viewfinder. This is called a so-called “crop,” and trimmable in the same manner as described above. Then, it is necessary to clearly inform the user of the digital zoom magnification or a trimmed range. Since the optical finder cannot directly display the digital zoom, for example, there is a method of changing the range of the viewfinder frame and of pseudo-displaying it.

The control apparatus (camera body 1) according to this embodiment includes the camera controller (calculator) 12 and the signal processing unit circuit (second processor) 10. The calculator determines the magnification of the digital zoom for the image based on the information (for example, the focal length in the optical zoom) corresponding to the position of the zoom ring (zoom cam barrel 5) that provides the optical zoom by a manual operation. The signal processing unit performs the digital zooming for the image based on the digital zoom magnification determined by the calculator. The calculator may determine the digital zoom magnification based on the wide-angle end focal length and the telephoto end focal length of the imaging optical system, and the focal length corresponding to the zoom ring position. The calculator acquires information corresponding to the zoom ring position by communicating with the interchangeable lens (imaging lens 2).

The calculator sets the magnification with the wide-angle end focal length to 1, sets the magnification with the telephoto end focal length to the maximum zoom magnification, and changes the magnification from the wide-angle end focal length to the telephoto end focal length in a range from 1 to the maximum zoom magnification. Alternatively, the calculator may set the magnification from the wide-angle end focal length to the first focal length to 1, sets the magnification from the second focal length to the telephoto end focal length to the maximum zoom magnification. Then, the calculator changes the magnification from the first focal length to the second focal length in a range from 1 to the maximum zoom magnification.

### Second Embodiment

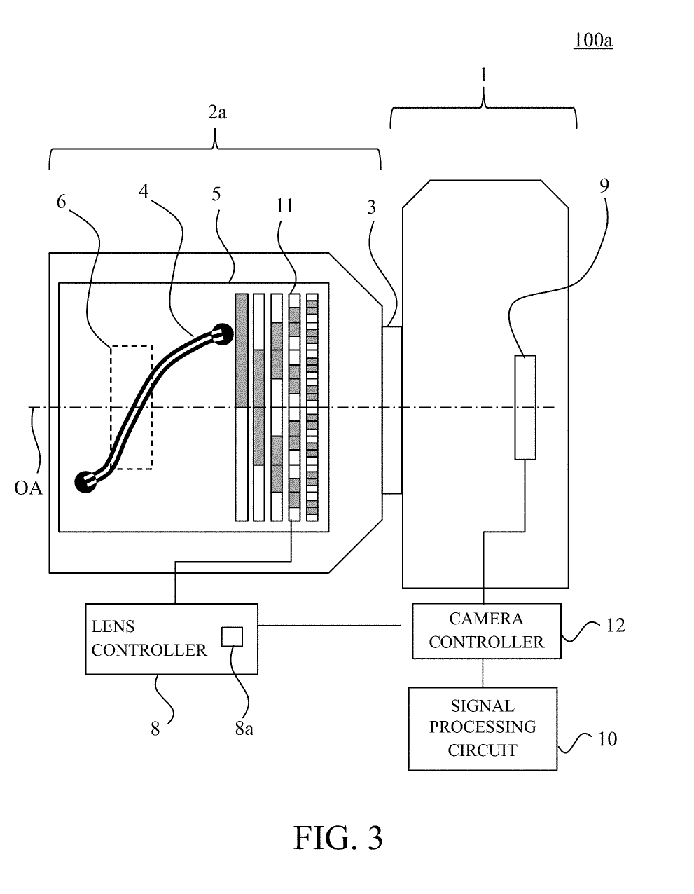

Referring now to FIG. 3, a description will be given of a configuration of an imaging apparatus according to the second embodiment of the present invention. FIG. 3 is a schematic diagram of an imaging apparatus (digital single-lens reflex camera) 100a.

The imaging apparatus 100a includes the camera body 1 and an imaging lens (interchangeable lens) 2a detachably attached to the camera body 1. The imaging apparatus 100a according to this embodiment is different from the imaging apparatus 100 according to the first embodiment in that it includes the imaging lens 2a that includes a zoom FPC (flexible printed circuit board for zoom operation) 11 instead of the imaging lens 2 that includes the zoom encoder 7. Since the other basic configuration is the same as that of the first embodiment, a description of the common configuration will be omitted.

The zoom FPC 11 can obtain the zoom position of the imaging lens 2a by detecting the rotational position of the zoom cam cylinder 5. The zoom FPC 11 includes five types of electrode patterns. When an unillustrated contact brush slides on this electronic pattern, the on/off of each type can be electrically detected. For example, where there are five electrode patterns as in this embodiment, there are thirty-two on/off patterns as 2 to the fifth power and thirty-two zoom states can be expressed. The range from the wide-angle end focal length to the telephoto end focal length is divided into 32, and a parameter is prepared as a database for each focal length of each zoom. The camera controller 12 uses the database and controls the focus of the imaging lens 2a, the aperture stop (diaphragm), the image stabilizing function (not illustrated), and the like.

The lens controller 8 includes a memory 8a that stores the database. As the zoom cam barrel 5 rotates by the zooming operation of the user, the electrode in contact with the contact brush varies. The lens controller 8 obtains the focal length information on the zoom based on the electrified electrode pattern, takes various parameter information corresponding to the zoom position from the database, transmits the parameter information to the camera controller 12, and controls driving of each component. The division number of parameters for each zoom position may be enough fine for the drive control accuracy, such as 32 or 64.

The lens controller 8 acquires the focal length f of the imaging lens 2a from the database based on the contact information on the zoom FPC 11 and transmits it to the camera controller 12. As in the first embodiment, the digital zoom magnification kx is calculated with the expression (1). This embodiment is different from the first embodiment in the process about the digital zoom magnification variation for the zoom operation by the user.

The limited number of divisions in detecting the zoom position using the zoom FPC 11 cannot provide a smooth digital zoom. FIG. 5 illustrates this state. FIG. 5 is a graph showing a change of the digital zoom magnification using the zoom FPC 11, which changes a digital zoom magnification in detecting the zoom position using the zoom FPC 11 when the optical zoom changes the magnification by the zoom operation of the user. In FIG. 5, the abscissa axis represents the rotational operation position of the zoom cam cylinder 5 (focal length of the optical zoom), and the ordinate axis represents the digital zoom magnification. The digital zoom magnification on the wide-angle end is 1.00. When the contact of the zoom FPC 11 is switched by the zoom operation, the digital zoom magnification changes stepwise like approximately 1.06 times, 1.13 times, and 1.19 times.

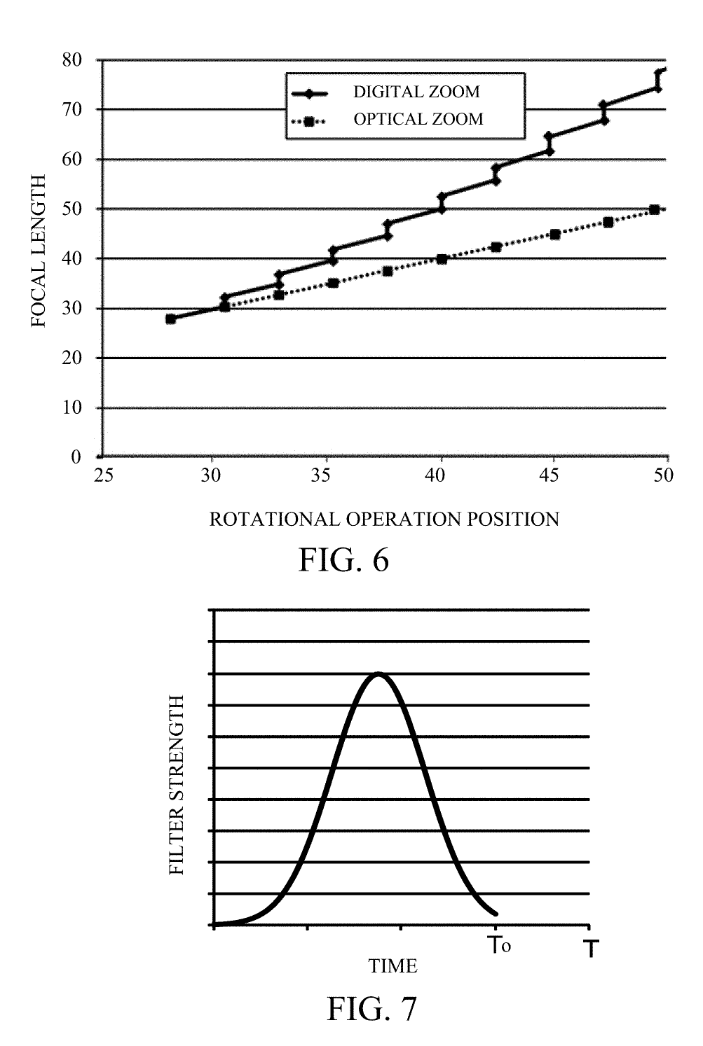

FIG. 6 is a graph illustrating a change of the digital zoom focal length using the zoom FPC 11. In FIG. 6, the abscissa axis represents a rotational position of the zoom cam cylinder 5 (focal length of the optical zoom), and the ordinate axis illustrates the focal length. In FIG. 6, the digital zoom focal length illustrated by the solid line is compared with the optical zoom focal length illustrated by the broken line. As illustrated in FIG. 6, a change in the digital zoom focal length draws a graph having a step for the optical zoom. Accordingly, the imaging lens 2a using the zoom FPC 11 needs to smooth the step-shaped digital zoom magnification by applying a filter in the time axis direction as illustrated in FIG. 7.

FIG. 7 shows an illustrative filter (smoothing filter in the time axis direction) with respect to the time response. In FIG. 7, the abscissa axis represents time and the ordinate axis represents the filter strength, respectively. The filter in FIG. 7 is made by cutting out part of the Gaussian distribution with time To. The filter strength illustrated on the ordinate axis in FIG. 7 is normalized so that the area is set to 1.

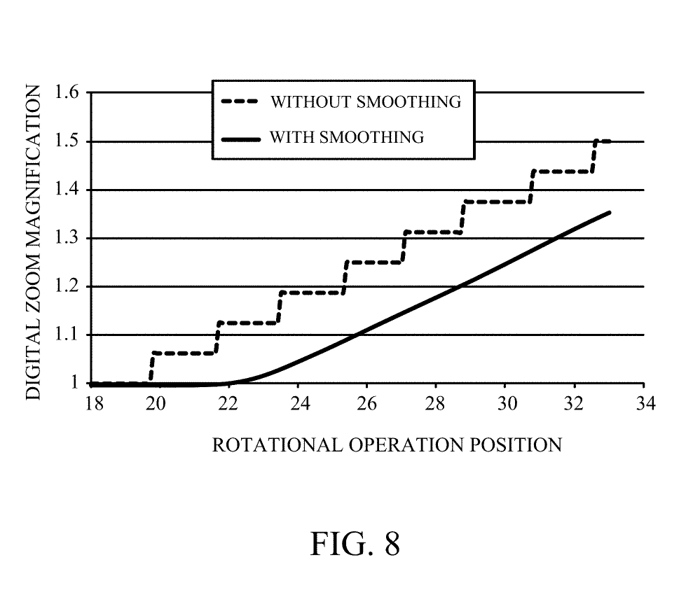

FIG. 8 is a graph illustrating a change of the digital zoom magnification after the smooth processing. In FIG. 8, the abscissa axis represents the rotational operation position (focal length of the optical zoom) of the zoom cam barrel 5, and the ordinate axis represents the digital zoom magnification. In FIG. 8, a solid line represents a smoothed change of the digital zoom magnification, and a broken line represents an unsmoothed change of the digital zoom magnification. FIG. 8 illustrates the result of the smooth processing by applying the filter illustrated in FIG. 7 to the digital zoom magnification, which corresponds to the result of convoluting the graph illustrated in FIG. 5. As illustrated in FIG. 8, the smooth processing smooths the change of the digital zoom magnification. The smoothing filter slightly delays the change of the digital zoom magnification after the magnification variation starts. This will provide smooth zoom starting. The smooth rotational operation of the zoom cam cylinder 5 is hard due to the maximum static friction applied at the start, and the zoom cam cylinder 5 often suddenly moves. Since the digital zoom enlarges the magnification variation, the change of the digital zoom magnification may be suppressed at the start of the movement.

The applied range of the smoothing filter corresponds to the spread in the time axis direction. Although a wider range application of the filter can promote smoothing by moving the time To in the graph illustrated in FIG. 7 in the abscissa axis direction (right direction), the response of the operability lowers. The applied range of the filter needs to be set in a well-balanced manner, and may be variable. Then, the applied range of the filter may be variable according to the zoom operating speed. The time To is set longer or the filter is widely applied in the time axis direction for slow zoom operation. For quick zoom operation, the time To is set shorter or the filter is shortly applied in the time axis direction.

The zoom operating speed can be detected by the inverse of the time interval when the zoom crosses the boundary of the zoom FPC 11 twice. The filter characteristic in the time axis direction is made variable based on the detected speed. This is one method of detecting the zoom operating speed based on the movement of the zoom FPC 11 and of changing the digital zoom magnification. Another method may detect a plurality of boundary switches of the zoom FPC and thereby the zoom operating speed, and determine the digital zoom magnification based on the zoom operating speed. The lens that acquires the zoom position with the zoom FPC 11 may detect a plurality of boundary switching time intervals of the zoom FPC 11.

The camera controller 12 performs these calculations and determines the digital zoom magnification. The signal processing circuit 10 performs image processing based on the digital zoom magnification. The above processing can provide smooth continuous digital zoom in response to the zoom operation of the user.

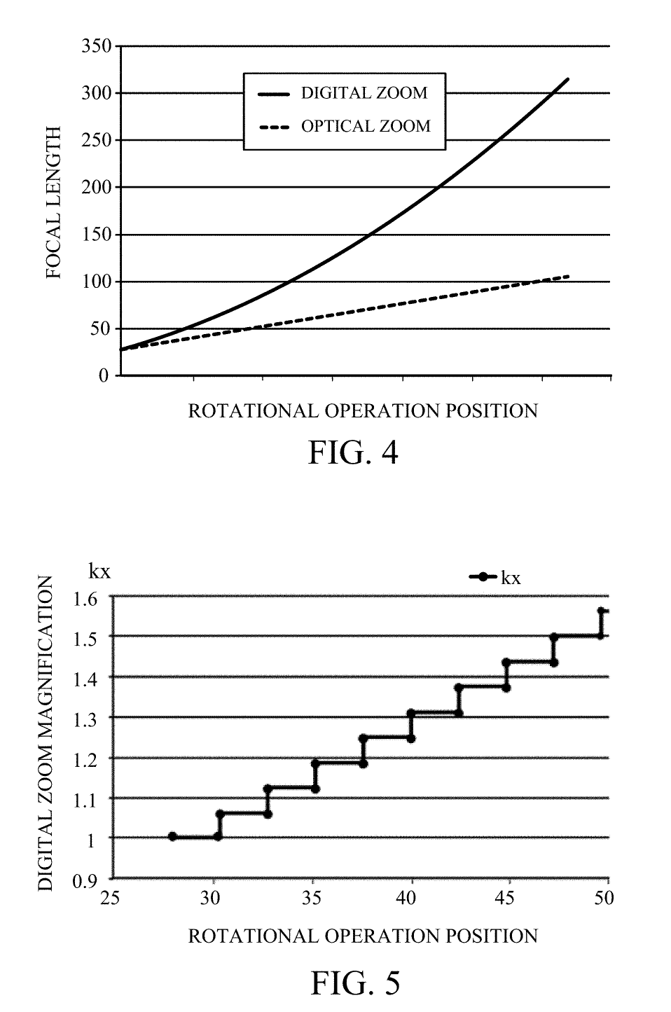

Referring now to FIG. 4, a description will be given of a relationship between the focal length change caused by the optical zoom made by the zoom operation and the focal length change caused by the digital zoom. FIG. 4 is a graph showing the relationship between the focal length change caused by the optical zoom made by the zoom operation and the focal length change caused by the digital zoom. The graph illustrated in FIG. 4 sets the maximum zoom magnification kmax to 3.0 for the zoom lens with a focal length of 28 mm to 105 mm. In FIG. 4, the ordinate axis represents the focal length. The abscissa axis represents the rotational operation position of the zoom cam barrel 5. The wide-angle end is located on the left side and the telephoto end is located on the right side. A broken line represents the focal length change caused by the optical zoom, and the focal length continuously changes from 28 mm to 105 mm. Then, the digital zoom magnification kx varies according to the equation (1). The focal length multiplied by them (digital zoom focal length as a combination of the optical zoom and the digital zoom) continuously varies from 28 mm to 315 mm as illustrated by the solid line in FIG. 4. This configuration can provide a high magnification-varying zoom lens with a zoom magnification corresponding to 11.25 times.

The calculator (camera controller 12) according to this embodiment performs filtering for temporally smoothing discrete changes of the digital zoom magnification. The calculator may change the filtering characteristic according to the information on the zoom ring operating speed (for example, a boundary switching time interval of the zoom FPC 11). When the zoom ring operating speed is a first operating speed, the calculator performs filter processing with a first characteristic (characteristic with a steep slope in the graph in FIG. 7). On the other hand, the calculator performs filter processing with a second characteristic (characteristic with a moderate slope in the graph in FIG. 7) for stronger smoothing than the first characteristic when the zoom ring operating speed is a second operating speed lower than the first operating speed.

This embodiment provides the same effects in the motion imaging as those in the first embodiment. It is important for a lens interchangeable digital single-lens reflex camera to maintain the compatibility with the imaging lenses released in the past. This embodiment can continuously and smoothly perform the digital zoom with the lenses released in the past.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Each embodiment can provide a control apparatus, an imaging apparatus, a control method, and a storage medium, each of which can provide smooth digital zoom via a manual operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, while each embodiment addresses the digital single-lens reflex camera, the present invention is not limited and is applicable to another type of camera, such as a non-reflex camera (mirrorless camera) and a video camera.

This application claims the benefit of Japanese Patent Application No. 2017-194919, filed on Oct. 5, 2017, which is hereby incorporated by reference herein in its entirety.

What is claimed is:

1. A control apparatus configured to control a lens apparatus having an operating unit for an optical zoom through a manual operation and an imaging apparatus configured to provide a digital zoom, the control apparatus comprising:
a first processor configured to determine a magnification of the digital zoom from a wide-angle end to a telephoto end based on information on a position of the operating unit; and
a second processor configured to cause the imaging apparatus to perform the digital zoom based on an output from the first processor.

2. The control apparatus according to claim 1, wherein the first processor determines the magnification based on a wide-angle end focal length and a telephoto end focal length of the lens apparatus, and a focal length corresponding to the position of the operating unit.

3. The control apparatus according to claim 2, wherein the first processor sets the magnification with the wide-angle end focal length to 1, sets the magnification with the telephoto end focal length to a maximum zoom magnification, and changes the magnification from the wide-angle end focal length to the telephoto end focal length in a range from 1 to the maximum zoom magnification.

4. The control apparatus according to claim 2, wherein the first processor sets the magnification from the wide-angle end focal length to a first focal length to 1, sets the magnification from a second focal length to the telephoto end focal length to a maximum zoom magnification, and changes the magnification from the first focal length to the second focal length in a range from 1 to the maximum zoom magnification.

5. The control apparatus according to claim 1, wherein the first processor performs filter processing for temporarily smoothing discrete changes of the magnification.

6. The control apparatus according to claim 5, wherein the first processor changes a characteristic of the filter processing in accordance with information on an operating speed of the operating unit.

7. The control apparatus according to claim 6, wherein the first processor performs the filter processing with a first characteristic when the operating speed of the operating unit is a first operating speed, and the filter processing with a second characteristic that is stronger in smoothing than the first characteristic when the operating speed of the operating unit is a second operating speed lower than the first operating speed.

8. An imaging apparatus comprising:
the control apparatus according to claim 1; and
an image sensor configured to photoelectrically convert an optical image formed by the lens apparatus.

9. The imaging apparatus according to claim 8, wherein the lens apparatus is detachable to the imaging apparatus, and the first processor acquires the information on the position of the operating unit through a communication with the lens apparatus.

10. The imaging apparatus according to claim 9, wherein the information on the position of the operating unit is information on a focal length of the lens apparatus.

11. A control method configured to control a lens apparatus having an operating unit for an optical zoom through a manual operation and an imaging apparatus configured to provide a digital zoom, the control method comprising the steps of:
determining a magnification of the digital zoom from a wide-angle end to a telephoto end based on information on a position of the operating unit; and
causing the imaging apparatus to perform the digital zoom based on the magnification.

12. A storage medium storing a program that enables a computer to execute a control method according to claim 11.
